(19) United States
(12) Patent Application Publication
(10) Pub. No.: US 2010/0204964 A1
(43) Pub. Date: Aug. 12, 2010

(54) LIDAR-ASSISTED MULTI-IMAGE MATCHING FOR 3-D MODEL AND SENSOR POSE REFINEMENT

(75) Inventors: Robert Taylor Pack, Logan, UT (US); Paul Israelsen, North Logan, UT (US)

Correspondence Address: UTAH STATE UNIVERSITY;Stoel Rives, 570 RESEARCH PARK WAY, SUITE 101, NORTH LOGAN, UT, 84341, US

(73) Assignee: Utah State University, North Logan, UT (US)

(21) Appl. No.: 12/563,894

(22) Filed: Sep. 21, 2009

Related U.S. Application Data
(63) Continuation-in-part of application No. 12/368,057, filed on Feb. 9, 2009.

(51) Int. Cl. G06F 17/50; G06F 17/10

(52) U.S. Cl. 703/1; 703/2

(57) ABSTRACT

A 3-D model of a subject matter may be constructed from a plurality of lidar shots and overlapping EO images of the subject matter. Each of the lidar shots may be mapped to image patches within two or more of the EO images using navigation data associated with the lidar shots and EO images. Each of the back-projected lidar points may be set as a centroid of an image patch (collection of pixels) within an EO image. With the aid of the lidar centroids, the image patches in overlapping EO images may be correlated and an image-based pixel-to-pixel coordinate association therebetween may be calculated. Using this refined pixel-to-pixel coordinate association, a 3-D model of the subject matter may be constructed and refined using photogrammetry techniques. Videogrammetry techniques, such as optical flow techniques, may be applied if a sufficient amount of EO imagery data is available.

### RELATED APPLICATIONS

This application is a continuation-in-part of U.S. patent application Ser. No. 12/368,057, entitled “Lidar-Assisted Stereo Imager,” filed Feb. 9, 2008, which is hereby incorporated by reference in its entirety.

### TECHNICAL FIELD

The present invention relates to three-dimensional (3-D) modeling. More specifically, the present invention relates to systems and methods for 3-D modeling and sensor pose refinement using correlatable EO imagery and lidar data.

### BRIEF DESCRIPTION OF THE DRAWINGS

Various embodiments of the invention are now described with reference to the figures, in which:

FIG. 1 is a block diagram of one embodiment of a lidar-assisted stereo imaging system;

FIG. 2A shows a plurality of overlapping EO images upon which are mapped a plurality of lidar shots;

FIG. 2B shows a lidar shot projection within a selected plurality of overlapping EO images;

FIG. 3 is a flow diagram of a method for constructing a 3-D model of a subject matter using correlatable EO images and lidar shots of the subject matter;

FIG. 4A shows lidar shot projections as centroids of respective bounding primitives on an EO image;

FIG. 4B shows a correlation between associated centroids in overlapping EO images;

FIG. 4C shows pixel-to-pixel coordinate associations within overlapping EO images;

FIG. 5 is a flow diagram of another method for constructing a 3-D model of a subject matter using correlatable EO images and lidar shots of the subject matter;

FIG. 6 is a flow diagram of a method for coloring a 3-D model of a subject matter;

FIG. 7 is a flow diagram for refining navigation data used to correlate EO images and lidar data; and

FIG. 8 is a block diagram of distinct components of a system for constructing a 3-D model of a subject matter using correlatable EO images and lidar shots of the subject matter.

### DETAILED DESCRIPTION

Modeling data comprising correlatable EO imagery and lidar data (lidar shots) may be used to construct a 3-D model of subject matter. The modeling data may be captured by an acquisition system having an EO imaging device and a lidar. The acquisition system may also gather correlation data as the EO imagery and lidar data are captured. The EO imaging device and/or lidar may be configured to operate synchronously and/or asynchronously. The correlation data may be used by a modeling process to correlate the EO images and/or lidar shots.

In some embodiments, the correlation data includes navigation and sensor pose (orientation) data. Lidar shots may be projected (mapped) onto an image plane of two or more of the EO images using the navigation and/or sensor orientation data. As will be described below, the lidar shot projections may be used to seed various image-processing operations within the EO image sequence, which, in turn, may be used to construct a 3-D model of the subject matter.

One example of a lidar and EO imagery capture system is provided in U.S. Pat. No. 7,417,717, to Dr. Robert Pack et al., and entitled “System and Method for Improving Lidar Data Fidelity Using Pixel-Aligned Lidar/Electro-Optic Data,” which is hereby incorporated by reference in its entirety. The co-pending application entitled, “Lidar-Assisted Stereo Imager,” Serial Num. TBD, filed Feb. 9, 2008 describes several systems and methods for capturing correlatable EO imagery and lidar data. However, the teachings of this disclosure could be used with any data acquisition system capable of capturing correlatable EO imagery and lidar data. Additional examples and descriptions of such acquisition systems are provided herein. Therefore, this disclosure should not be read as limited to any particular acquisition system and/or acquisition technique.

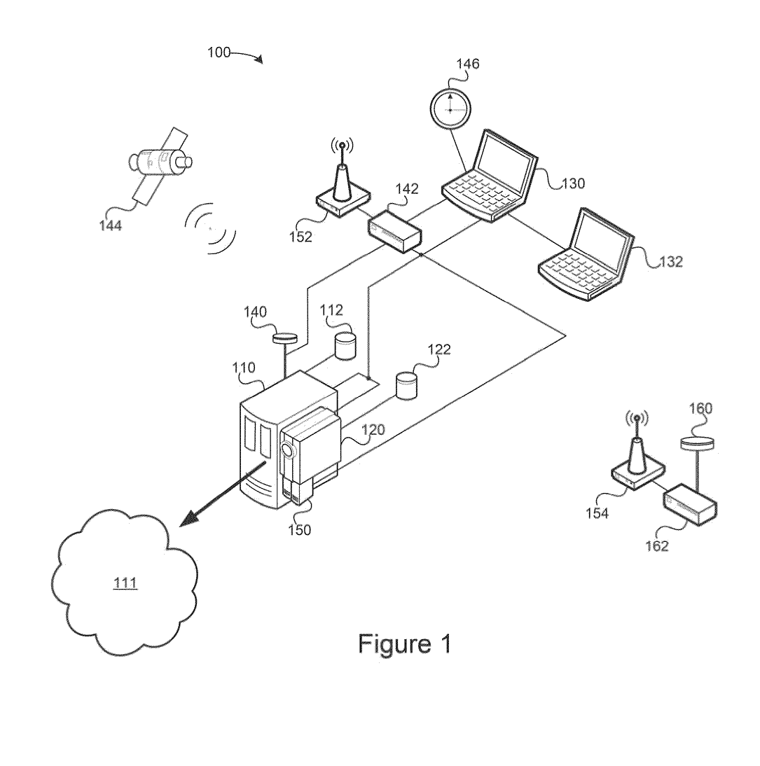

FIG. 1 shows another embodiment of an acquisition system 100 capable of capturing correlatable EO and lidar data. The acquisition system 100 includes a lidar 110 and an EO imaging device 120, which may capture data (EO imagery and lidar shots) relating to a subject matter 111. The lidar 110 and EO imaging device 120 are coupled to respective data stores 112 and 122, which may be used to store data captured thereby.

The data stores 112 and 122 may include any data storage media and/or data storage technique known in the art including, but not limited to: a magnetic disc,

Flash memory, a database, a directory service, optical media, a storage area network (SAN), a redundant array of inexpensive discs (RAID), a combination of data storage media, or the like.

The subject matter 111 may be any structure including, but not limited to: an object (e.g., car, aircraft, sculpture, or the like), a landscape, a geographical area, a cityscape, a geographical feature, terrain, an extraterrestrial object, a coastline, ocean floor, or the like.

A system controller 130 controls the operation of the lidar 110 and the EO imaging device 120. The system controller 130 may be further configured to capture navigation and sensor orientation information as EO imagery and lidar data are acquired. Navigation and/or orientation data may be captured using a positioning system receiver 142 and antenna 140 configured to receive positioning (navigation) information from a positioning system transmitter 144 (e.g., GPS satellite or the like). The position information may be stored in the data store 112 and/or 122.

In some embodiments, the system controller 130 refines the position of the system 100 using data gathered by a second positioning system (e.g., antenna 160 and receiver 162). The second positioning system (comprising antenna 160 and receiver 162) may be disposed at a known, fixed location and may include a transmitter 154 to transmit positioning information to the system controller 130 (e.g., via a receiver 152). Since the second positioning system antenna 160 is at a fixed location, changes to the position of the second system may be attributed to positioning system error. The system controller 130 may detect such error conditions for use in refining the positioning information received by the receiver 142.

The system controller 130 is coupled to an inertial measurement unit (IMU) 150, which is coupled to the lidar 110 and/or EO imaging device 120. The IMU 150 may determine an orientation, acceleration, velocity, of the lidar 110 and/or EO imaging device. The system controller 130 may include this information in the navigation and/or sensor orientation information. The IMU 150 may include one or more accelerometers, gyroscopes, or the like.

The system controller 130 may time stamp navigation, sensor orientation, EO imagery, and/or lidar data as it is acquired. The time stamp information may be included in the modeling data captured by the system 100 for use in associating EO images and/or lidar shots with respective navigation and/or sensor orientation data. The system controller 130 may be communicatively coupled to a time source 146 to provide time stamp data.

The system 100 includes a modeler 132, which may access the modeling data captured by the acquisition system 100 to construct a 3-D model of the subject matter. The modeling data may include correlation data, such as navigation, sensor orientation, and/or timing data associated with the EO images and lidar shots captured by the system 100. The modeler 132 uses the correlation data to correlate (e.g., map or project) lidar shots onto one or more overlapping EO images.

The modeler 132 may be configured to correlate EO image and lidar data using any number of different techniques including, but not limited to: sensor synchronism; time stamping; navigation/sensor pose information, sensor alignment; sensor movement according to a fixed or known pattern; or the like. For example, the modeling data may have been captured synchronously and, as such, may be correlated using information regarding the FOV and/or relative offset or scan pattern of the EO imaging device 120 and lidar 110. Alternatively, or in addition, the EO imagery and lidar data may have been captured while moving according to a known or fixed movement pattern (e.g., the system 100 may include a movable mount (not shown), such as a crane, gimbal, or the like). The modeling data may include the movement pattern, which may be used to correlate the EO imagery and lidar data.

As discussed above, the systems and methods for 3-D modeling disclosed herein may be used with any type of correlatable EO and lidar data. Therefore, this disclosure should not be read as limited to any particular correlation data type and/or data correlation method or technique.

As the modeler 132 constructs a 3-D model of the subject matter, it may also refine the correlation data (e.g., navigation and/or sensor orientation data) acquired by the system 100. Therefore, the modeler 132 may include a feedback path by which the navigation and/or sensor pose refinements may flow to the system controller 130. The system controller 130 may be configured to use the refinement data (e.g., error signals or the like) to display, diagnose, and/or correct errors in navigation and/or sensor orientation data it collects.

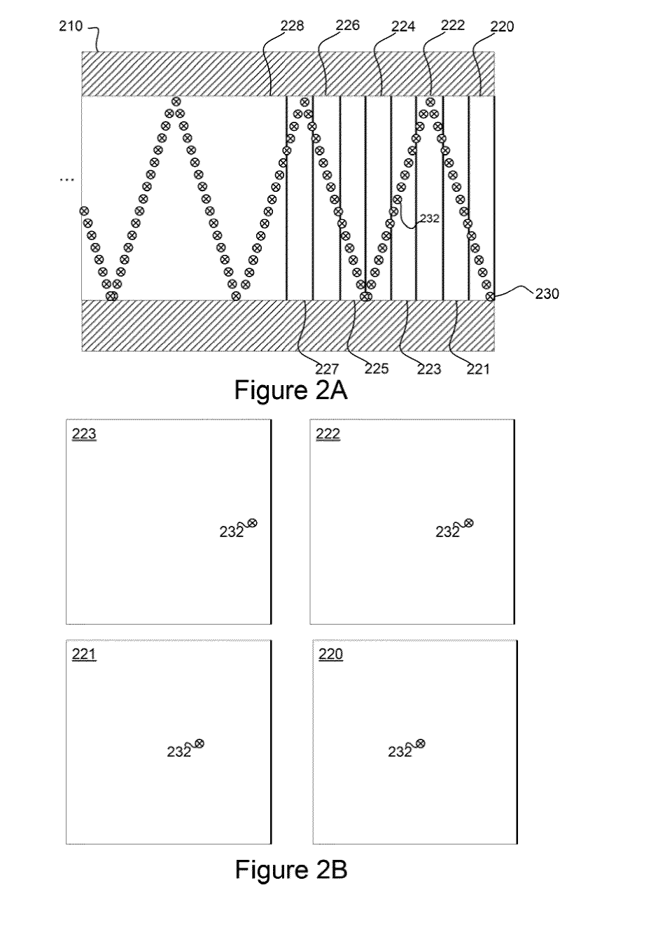

FIG. 2A shows an example of an area 210 captured by a plurality of correlatable EO images 220-228 and lidar shots 230. The correlatable data shown in FIGS. 2A and 2B may have been captured by the system 100 discussed above, or another system capable of capturing correlatable EO imagery and lidar data of a subject matter.

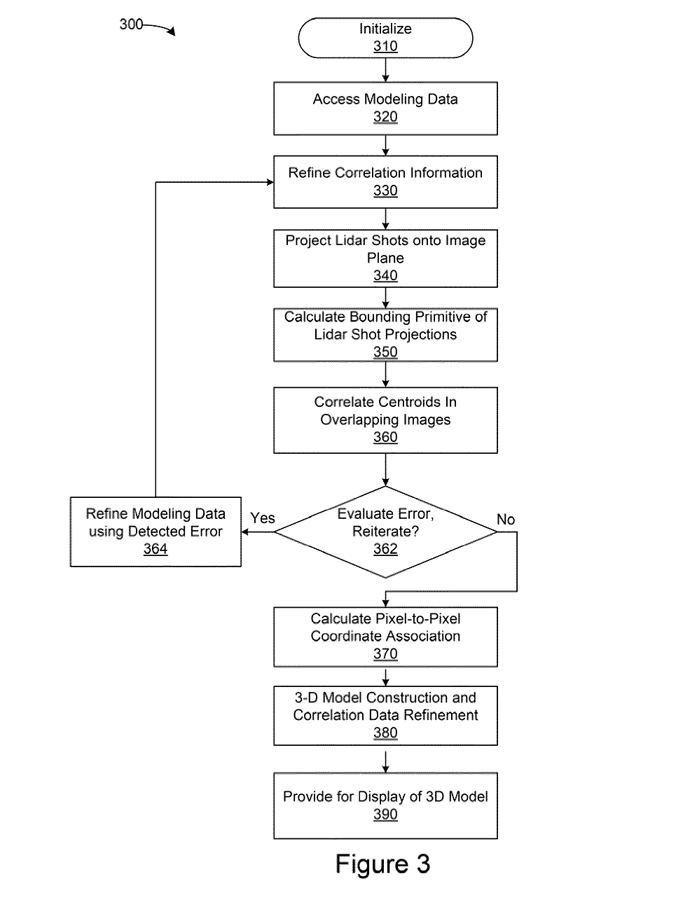

As shown in FIG. 2A, the EO images 220-228 and lidar shots 230 may be correlated, such that an FOV and/or area of overlap of the EO images 220-228 may be determined. In addition, the correlation may allow the lidar shots 230 to be projected (mapped) onto a selected plurality of the EO images 220-228. Various examples of techniques for mapping and/or projecting lidar shots onto EO images are discussed below in conjunction with, inter alia, FIGS. 3, 4, and 7.

As shown in FIG. 2A, plural lidar shots 230 may project/map onto respective image patches (groups of pixels) within the image plane of a selected plurality of EO images 220-228. Moreover, since the EO images 220-228 overlap one another, a single lidar shot may project/map onto more than one of the EO images 220-228. For example, FIGS. 2A and 2B show the lidar shot 232 projecting/mapping onto the FOV of four (4) EO images 220-223.

FIG. 2B shows the mapping/projection of the lidar shot 232 onto the EO images 220-223. As used herein, mapping or projecting a lidar shot onto an EO image may comprise identifying one or more pixels within the EO image (an image patch) upon which the lidar shot projects based upon the FOV of the EO image, the size of the lidar footprint, and/or the correlation data associated with the lidar shot. For example, if navigation and/or sensor orientation correlation data is used, the FOV of the image may be determined according to the position and/or orientation of the EO imaging device used to capture the image at the time the EO image was captured. The position of the lidar shot “footprint” may be similarly determined (e.g., from the position and/or orientation of the lidar at the time the lidar shot was captured). An area of overlap between the FOV of the EO image and the lidar shot may then be estimated. This overlap may be the lidar shot “footprint” as projected onto a group of pixels within the EO image. The size of the lidar footprint within the EO image may depend upon the resolution of the EO image, coherency of the lidar, actual footprint of the lidar beam, etc. The resulting mapping/projection may comprise a group of pixels within the EO image, which may be referred to herein as an “image patch.” As will be discussed below, the mapping/projection may be refined using various image-processing techniques including, but not limited to: visibility techniques, using depth mapping, orthogonalization, and the like. Of course, if the modeling data is correlated using other types of correlation data (e.g., synchronism, movement pattern, etc.), other mapping/projection methods or techniques may be applied.

The lidar shot-to-EO image projections/mappings shown in FIGS. 2A and 2B may be used by a modeler to construct a 3-D model of a subject matter. The 3-D model may be constructed from the overlapping EO images using an image processing technique, such as stereo imaging, photogrammetry, videogrammetry, optical flow, or the like. As will be discussed below, many of these EO image-based techniques involve EO image matching operations within an EO image sequence (e.g., matching EO image patches, pixels, and the like). The lidar shot projections/mappings shown and described in FIGS. 2A and 28 may be used to seed these image-matching techniques.

For example, FIG. 2B shows the lidar shot 232 projecting/mapping onto different portions (e.g., image patches) of four (4) EO images 220-223. These lidar shot mapping/projections 232 may be used to seed image-matching techniques applied to the EO images 220-223. For example, the location of the lidar shot projections/mappings 232 represent the same portion of the subject matter as captured in the (4) different EO images 220-223. Therefore, the locations of the lidar projections 232 in each of the EO images 220-223 should match and, as such, may be used to seed various image processing (image matching) techniques.

Although FIGS. 2A and 2B show a lidar shot mapping/projection 232 within four (4) overlapping EO images 220-223, one skilled in the art would recognize that the a lidar shot could project onto any number of overlapping EO images depending upon the capture rate of the EO imaging device, the capture rate and/or scan pattern of the lidar, movement speed of the system used to acquire the data, and the like. For example, in some configurations, lidar shots may be projected/mapped onto 10s to 100s (or more) of overlapping EO images.

The EO imagery data may have a higher spatial resolution than the lidar data (e.g., the pixel density of the EO imagery data may be greater than the lidar shot density). Similarly, the EO imagery data may have been captured at a higher rate than the lidar data. For example, the EO images may have been captured by a high-rate capture device, such as a high definition (HD) video camera, a high-rate digital camera, or the like. The high resolution and high capture rate of the EO imaging device may allow for the acquisition of a plurality of high-definition, overlapping EO images of the subject matter. As discussed above, the EO imagery overlap may cause a particular portion of the subject matter to be captured within a few, to 10s, 100s, or more overlapping EO images (e.g., from different locations, points-of-view, or the like). This large amount of high-resolution EO imagery data may be leveraged to construct a high fidelity 3-D model of the subject matter.

FIG. 3 is a flow diagram of one embodiment of a method 300 for constructing a 3-D model of a subject matter using correlatable EO imagery and lidar data. The method 300 may be implemented as one or more computer-readable instructions, which may be adapted for operation on a computing device comprising a processor, data storage media, communications interface, human machine interface (HMI), and the like. The one or more instructions comprising the method 300 may be embodied as distinct modules on a computer-readable medium communicatively coupled to the computing device.

At step 310, the method 300 may be initialized, which may include allocating processing resources, allocating and/or initializing data storage resources, allocating one or more memory storage locations, allocating and/or initializing one or more communications interfaces, and the like. The initialization may further comprise accessing a computer-readable storage medium upon which computer readable instructions for implementing the method 300 are embodied.

At step 320, a set of modeling data may be accessed. The modeling data may include a plurality of correlatable EO images (e.g., an image sequence) and lidar shots of a subject matter. The modeling data may include correlation data, which may be used to correlate the EO images and lidar shots. As will be discussed below, in some embodiments, the correlation data may include navigation and/or sensor orientation data associated with the EO images and lidar shots. At step 330, the modeling data may be refined by correlating the lidar data with the correlation data associated therewith. The refining of step 330 may allow for a more accurate mapping/projection of the lidar shots onto selected EO images at step 340. As discussed above, the correlation data may include navigation data and/or sensor orientation estimates. In these embodiments, the refining of step 330 may comprise applying a point cloud matching technique, such as iterative closest point (ICP) to the lidar and navigation data to determine a minimal error transformation therebetween. As applied at step 330, the point cloud matching refinement may comprise iteratively computing transforms between the lidar and correlation data (e.g., navigation and/or sensor orientation estimates) until an optimal (minimum error) transform is determined (or an iteration limit is reached). The resulting optimal transform may then be used to refine the correlation data (e.g., the navigation and/or sensor pose data may be refined to correspond to the optimal transform). As discussed above, the correlation data may include navigation and/or sensor orientation data associated with the lidar shots. The navigation and/or sensor orientation data may be used to project (map) each lidar shot onto the subject matter (e.g., onto a “footprint” on the subject matter). In addition, the lidar shots may themselves be captured according to a known scan pattern and, as such, may have a known structure (e.g., a regular structure defined by the lidar scan pattern). Therefore, relative positions of the lidar shots to one another may be defined and/or estimated according to the lidar shot structure (e.g., the location of a first lidar shot in a lidar shot sequence may be derived from the location of a second lidar shot, and so on).

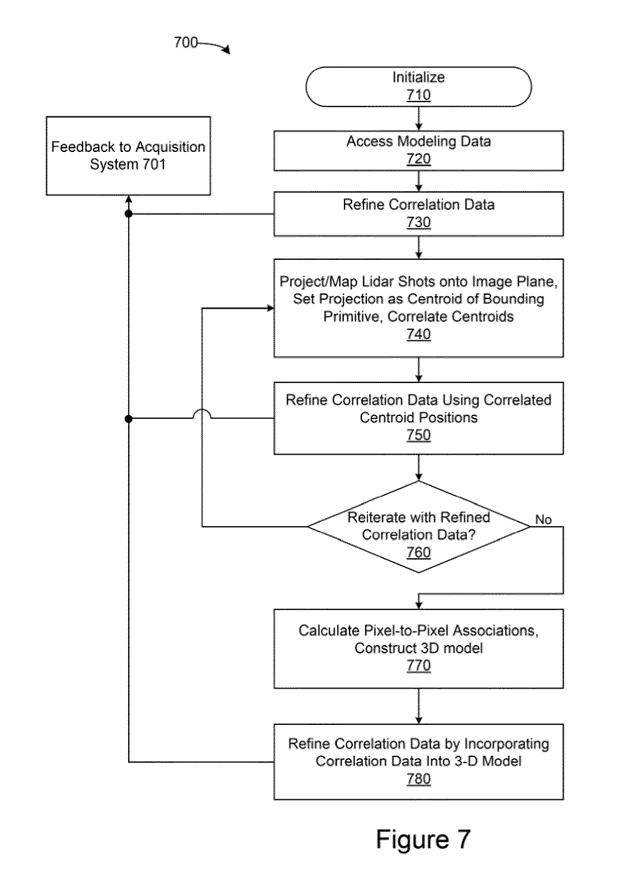

Therefore, the point cloud matching technique of step 330 may comprise iteratively comparing the lidar shot projections calculated using the navigation and/or sensor orientation data to the known lidar shot structure or pattern. During each iteration, the correlation data may be refined and the current correlation data estimate may be evaluated using a cost function related to a difference between the projections calculated using the navigation data and the lidar shot structure (e.g., mean square cost or the like). The refinement may continue until an error criterion (e.g., error threshold, iteration count, or the like) is reached. In other embodiments, the point cloud matching refinement technique described above may be applied to refine other types of correlation data, such as time stamp correlation data, synchronism, movement pattern, and so on. The navigation refinements calculated at step 330 may be applicable to other portions of the modeling data. For example, the navigation estimates may be off by a particular offset and/or in a recurring pattern. Therefore, refining of step 330 may include a feedback path (not shown) by which refinements to the correlation data may flow back to step 330 for use with other portions of the modeling data. The feedback path may also flow to an acquisition system or method (not shown), to allow for detection and/or correction of systemic error conditions. One example of a feedback path is provided below in conjunction with FIG. 7.

At step 340, the refined correlation data may be used to correlate the lidar shots with the EO images. The correlation may include determining a FOV for each of the EO images using the refined navigation and/or sensor orientation estimates to construct an image plane comprising a sequence of overlapping EO images.

Step 340 may comprise projecting or “back-projecting” the lidar shots onto the image plane of the EO images. As used herein, projection or back-projection may refer to a process or technique for determining (e.g., estimating or predicting) the position of an object in the FOV of one sensor (e.g., an EO imaging device) given its position in the FOV of another sensor. Therefore, back-projection may comprise mapping a pixel coordinate in one sensor to a pixel coordinate in the other sensor. At step 340, the lidar shots may be back projected onto the image plane using the refined navigation data (e.g., sensor position and orientation) calculated at step 330.

In some embodiments, back projecting a lidar shot onto the image plane may comprise calculating a 3D coordinate (e.g., XZY position) of the lidar footprint in a global coordinate system (e.g., on the subject matter 111 of FIG. 1) using the refined navigation data (e.g., the position and/or orientation of the lidar) and the range data provided by the lidar (e.g., in the lidar shot). The 3D coordinates of the lidar footprint may then be translated into the EO image plane using the refined navigation data (e.g., the position and/or orientation of the EO imaging device).

The projection/mapping of step 340 may be performed in a single operation (all of the lidar shots may be mapped onto the image plane in a single step) or, alternatively, may be performed on a piecewise basis (e.g., as portions of the modeling data are streamed through the method 300).

At step 350, each of the lidar shot projections within each EO image are set as centroids of respective image patches therein. In addition, at step 350, each image patch (lidar shot projection) may be set as the centroid of a bounding primitive within the EO image. The bounding primitives may include polygons (e.g., triangles), bounding spheres, Voroni cells, or other primitive types. The boundaries of the bounding primitives may be defined according to a bounding primitive definition technique, such as k-nearest neighbor, a distance metric (distance from the bounding primitive centroid), or the like. For example, a Voroni cell bounding primitive may be defined using a distance metric, such that each pixel within the Voroni cell is closer to the centroid of the Voroni cell than to the centroid of any other Voroni cell within the EO image.

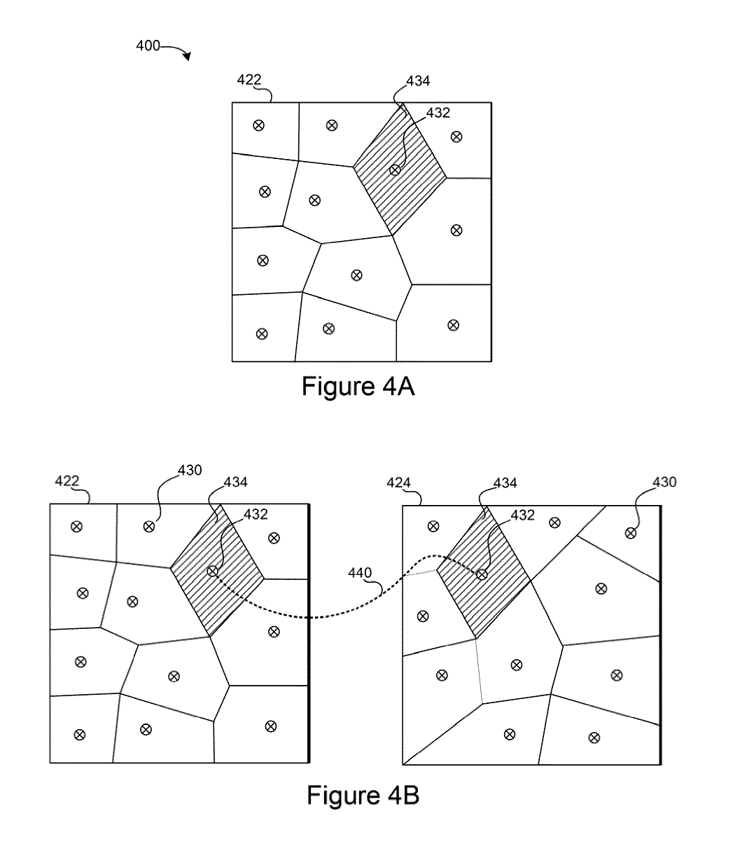

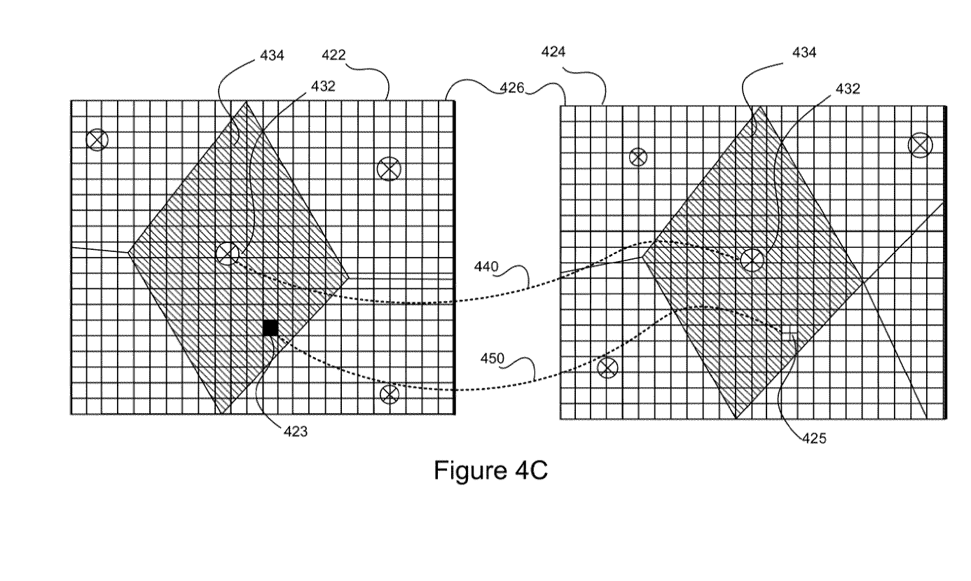

FIG. 4A shows an example of an EO image 422 having a plurality of lidar shots projections thereon (e.g., lidar projections 432). The lidar shot projections may have been estimated using the refined navigation and/or sensor orientation information discussed above. The projection calculation may have further included the back-projection and/or orthogonalization processes discussed above.

In FIG. 4A, each of the lidar shots (e.g., lidar shot 432) has been set as the centroid of a Voroni cell bounding primitive as described above in connection with step 350 of FIG. 3. Accordingly, each of the EO image 422 pixels (not shown) within a particular Voroni cell is closer to the centroid of its cell than to any other centroid within the EO image 422.

Referring again to FIG. 3, the modeling data accessed at step 320 may comprise an EO image sequence comprising a plurality of overlapping EO images. Therefore, a particular lidar shot (e.g., lidar shot projected onto the image plane) may be projected onto a plurality of overlapping EO images. That is, after performing steps 310-350, a particular lidar shot may be projected, and have a corresponding centroid location and bounding primitive, within a selected plurality of EO images within the EO image sequence. Therefore, the lidar shot mappings may be used to “seed” an image match process between EO images within the EO image sequence.

At step 360, the centroids of associated image patches (e.g., image patches of the same lidar shot projection in different EO images) may be correlated (matched) using image processing techniques. In the FIG. 3 embodiment, this may comprise aligning the centroid positions of bounding primitives (e.g., Voroni cells) associated with the same lidar shot projection in two (2) or more overlapping EO images.

FIG. 4B shows an example of the same lidar shot projecting into in two (2) EO images 422 and 424 (the lidar shot projection is marked as 432 in both EO images 422 and 424). The EO images 422 and 424 may have been obtained from different positions and/or orientations relative to the subject matter. As such, the lidar shot projection 432 may fall within different portions of the images 422 and 424. Moreover, although in FIG. 4B the Voroni cells 434 and 435 in the EO images 422-424 are shown as having substantially the same size and dimensions, such may not always be the case due to the fact that, inter alia, different lidar projection distributions may exist within the images 422 and 424.

FIG. 4B shows an example of a correlation (line 440) between bounding primitive centroids in two (2) EO images 422 and 424. The correlation 440 may represent an image-based match between the location of the lidar shot projection 432 within the EO image 422 and the lidar shot projection 432 within EO image 424. As can be seen in FIG. 4B, the image-based correlation 440 may be seeded using the lidar shot projection 432 and/or the bounding primitives 434 and 435 (e.g., the image-based matching operation may be confined to the vicinity of the centroids 432 and/or bounding primitives 434 and 435 within the EO images 422 and 424).

Referring again to FIG. 3, the centroid correlation of step 360 may further include refining the correlation data (e.g., detecting errors within the initial lidar shot projections estimated at steps 330-340 and/or the bounding primitive centroid locations of step 350). As discussed above, the EO imagery data may be of a higher resolution than the lidar shot data. Therefore, the EO imagery data may represent an independent and more accurate source of EO image correlation than the non image-based correlation data used at steps 330-350. As such, the image-processing techniques applied at step 360 may result in a more accurate and/or higher precision lidar shot projection locations than those used to seed step 360. A correlation data error may therefore be calculated as differences between the positions of the correlated centroid positions calculated at step 360 and the lidar shot projections calculated using the correlation data at steps 330-350.

In embodiments where other correlation data and/or correlation techniques are used (e.g., other than navigation and/or sensor orientation correlation techniques discussed in connection with FIG. 3), error conditions may be similarly detected. For example, if the correlation data comprises synchronism information (e.g., indicates sets of EO images and/or lidar shots that were captured at the same time), the correlation of step 360 may detect a loss of synchronism and/or synchronism errors in particular portions of the modeling data (e.g., as indicated by lidar shot projection drift or the like). Likewise, if the modeling data comprises time stamp information, time drift error may be detected and corrected by observing unexpected lidar shot projection shift between EO images (e.g., lidar shot mappings may be shifted between images more or less than expected). As can be appreciated by one of skill in the art, the correlation of step 360 may be used to detect measurement and/or projection error according to the type of correlation data and/or data correlation technique used in the method 300. Therefore, this disclosure should not be read as limited to detecting a particular error type using any particular error detection method.

Although not shown in FIG. 3, the refinements to the correlation data (including any errors detected therein) may flow to a feedback path (not shown) for use in refining other portions of the modeling data, refining the operation of an acquisition system or method (e.g., refining the systems and methods used to acquire navigation and/or sensor orientation data), for display to a user via an HMI, or the like. One example of such a feedback path is discussed below in conjunction with FIG. 7.

In some embodiments, the error detected at step 360 may be evaluated to determine whether the steps 320-350 should be reiterated using the refined correlation data. For example, the refinements determined at step 360 may be compared to one or more predefined thresholds, which may be set to balance an expected improvement in the correlation results (calculated at steps 330-360) using the refined correlation data against a cost of reiterating the steps 330-360 (e.g., in time, computing power, or the like). The threshold may also include an iteration limit which, when reached, may preclude further iterations over steps 330-360. In embodiments where portions of the modeling data area streamed through the method 300 (e.g., the method 300 operates on only a portion of the modeling data at a time), the determining of step 362 may include evaluating whether the refinement would improve the results of steps 330-360 as applied to other portions of the modeling data (e.g., whether the error is likely to be persistent within the modeling data or is localized to the portion of modeling data currently being processed). For instance, if the modeling data of step 320 is part of a larger model of the subject matter (e.g., is a local point cloud within the super-resolution model of the subject matter), the correction data refinements of step 362 may be applied to the other, related point clouds, which may allow for more precise point cloud merging.

If the determining of step 362 indicates that steps 330-360 should be reiterated using refined correlation data, the flow may continue at step 364; otherwise, the flow may continue at step 370.

At step 364, the modeling data may be refined using the error detected at step 360. The refinement may comprise correcting the correlation data of the particular portion of modeling data currently being processed by the method 300. Alternatively, or in addition, the refinement of step 364 may be applied to other portions of the modeling data and/or to other sets of related modeling data (e.g., modeling data comprising other portions of a super-resolution model of a particular subject matter to facilitate point cloud merging). Following the refinement of step 364, the flow may continue back at step 330 where steps 330-362 may be reiterated.

At step 370, pixel-to-pixel coordinate associations between pixels in overlapping EO images may be calculated using image processing techniques. The image processing techniques used to calculate the pixel-to-pixel coordinate associations may be seeded using the correlated bounding primitives of step 360.

Due to the seeding information provided by the lidar shot projections (and the depth map information discussed above), the search space for the pixel-to-pixel coordinate associations may be limited (e.g., to image patches (bounding primitives) within overlapping EO images and/or to particular depth planes within the EO images). This seeding may prevent the image processing technique from converging to local minima. Moreover, the seeding may reduce the compute time and other resources required to calculate the pixel-to-pixel coordinate associations.

FIG. 4C shows a close-up view of Voroni cell bounding primitives 434 and 435 projected onto two (2) EO images 422 and 424. Pixel boundaries are depicted by a grid 426. Although the pixel boundaries in FIG. 4C are depicted as being rectangular, the teachings of this disclosure could be applied to other pixel boundary types and/or representations, such as spherical pixels, pixel cells, pixel volumes (voxels), or the like. Although FIG. 4C depicts a particular pixel-size of the lidar projection footprints (e.g., lidar projection 432), this disclosure should not be read as limited to any particular lidar projection size. The teachings of this disclosure may be applied under various different scenarios, each of which may result in a different lidar shot projection pixel size. For instance, the pixel-size of lidar projection footprints may vary depending upon the resolution of the EO imaging device used to capture the EO images, the convergence of the lidar used to capture the lidar shots, the optical characteristics of the EO imaging device and/or lidar, and so on. The projection step (step 340) may apply these (and other factors) in determining an appropriate lidar projection footprint on the EO image plane.

FIG. 4C shows a pixel-to-pixel coordinate association 450 between a pixel and/or pixel coordinate 423 in the EO image 422 and a pixel coordinate 425 in the EO image 424. As discussed above, pixel-to-pixel coordinate associations between overlapping EO images (e.g., association 450) may be determined using various image-processing techniques, which may be seeded using the lidar projections 432, the bounding primitives 434 and 435, and/or depth mapping information (not shown). The seeding may limit the search space for the pixel-to-pixel coordinate association image processing technique to pixels within the vicinity of associated lidar shot projections (e.g., within the bounding primitive of the lidar shot projection) and/or to a common depth. For example, FIG. 4C shows a pixel-to-pixel coordinate association 450 between pixels within the bounding primitives 434 and 435 of the same lidar shot projection 432).

Referring back to FIG. 3, at step 380, a 3-D model of the subject matter is constructed using the pixel-to-pixel coordinate associations. In one embodiment, each pixel-to-pixel coordinate association may yield a 3-D point within the model. The 3-D points may be calculated using an image-based 3-D modeling technique, such as stereo imaging, photogrammetry, or the like. The resulting 3-D model may have substantially the same spatial resolution as its constituent EO images. Therefore, the 3-D model may have a significantly higher resolution than a 3-D model constructed using only the lidar data (e.g., with the EO imagery providing only texture information).

In some embodiments, the 3-D model construction of step 380 may include refining one or more of the 3-D points. As discussed above, the EO imagery may comprise significant EO image overlap, such that a particular portion of the subject matter is captured by several to 10s, 100sm or more EO images. Separate pixel-to-pixel coordinate associations (and respective 3-D points) may be calculated between each pair of overlapping EO images. An error-minimizing algorithm may be applied to the 3-D point solution space to yield a refined position of the 3-D point. For example, a 3-D point may be refined using a least-squared error solution between two (2) or more 3-D points, calculated using pixel-to-pixel coordinate associations between three (3) or more EO images.

The 3-D model construction of step 380 may further include refining the correlation data. As discussed above, the 3-D model constructed at step 380 may be of a higher-resolution than the lidar data and/or the correlation data. Therefore, the resulting 3-D model may be used to refine the correlation data (e.g., navigation and/or sensor pose estimates). Moreover, since the 3-D points may incorporate a significant amount of overlapping EO imagery data, the model may be statistically robust (e.g., the same 3-D point may be calculated by minimizing an error metric between plural 3-D point estimates derived from plural pixel-to-pixel coordinate associations). Therefore, each 3-D point may be derived using contributions from plural, redundant sources.

The correlation data refinement of step 380 may comprise incorporating the correlation data into the 3-D model of the subject matter. For example, in embodiments in which the correlation data includes navigation and/or sensor orientation estimates, step 380 may include placing the acquisition platform (e.g., the EO imaging device and/or lidar) into the 3-D model by inter alia back projecting the lidar shot projections and/or EO images to their respective sources. In embodiments where the modeling data includes EO images and/or lidar shots captured over time (and from various different positions relative to the subject matter), this placement may similarly include a plurality of different placements of the acquisition system within the 3-D model.

The acquisition platform placement(s) within the 3-D model may be compared against the original navigation and/or orientation data. The navigation and/or orientation correlation data may then be refined by conforming the correlation data to the positions calculated according to the 3-D modeling data (e.g., divergence between the position of the acquisition platform calculated using the 3-D model and the original correlation data may be detected as an error within the correlation data, which may be refined accordingly).

As described above, the correlation data refinements (e.g., errors) may be stored for analysis, flow via a feedback path (not shown), and/or be used to refine other point clouds in a super-resolution model and/or other portions of the modeling data.

At step 390, the 3-D model may be made available for display to and/or manipulation by a human user. The display of step 390 may be made through an HMI, which may be implemented on a computing device comprising one or more processors, memory modules, communications interfaces, displays, input/output devices, and the like. The display may include a video display (e.g., CRT monitor, LCD monitor, or the like), a holographic display, or another display type. The HMI may allow the user to navigate within the 3-D model, zoom into various portions of the model, apply notations to the model, apply texture information to the model (discussed below), manipulate the model, and so on. Therefore, the HMI and/or the computing device on which the HMI is implemented may include a renderer capable of parsing and displaying the 3-D model of the subject matter constructed at step 380.

In addition, at step 390, the data comprising the 3-D model may be stored in a data storage medium. The data storage medium may include, but is not limited to a memory, a magnetic disc, optical data storage media, a network storage media, a storage area network (SAN), a redundant array of inexpensive discs (RAID), a combination of storage media, or the like. The data storage media may be coupled to a communications interface to allow the 3-D model stored thereon to be available to remote computing devices on a network.

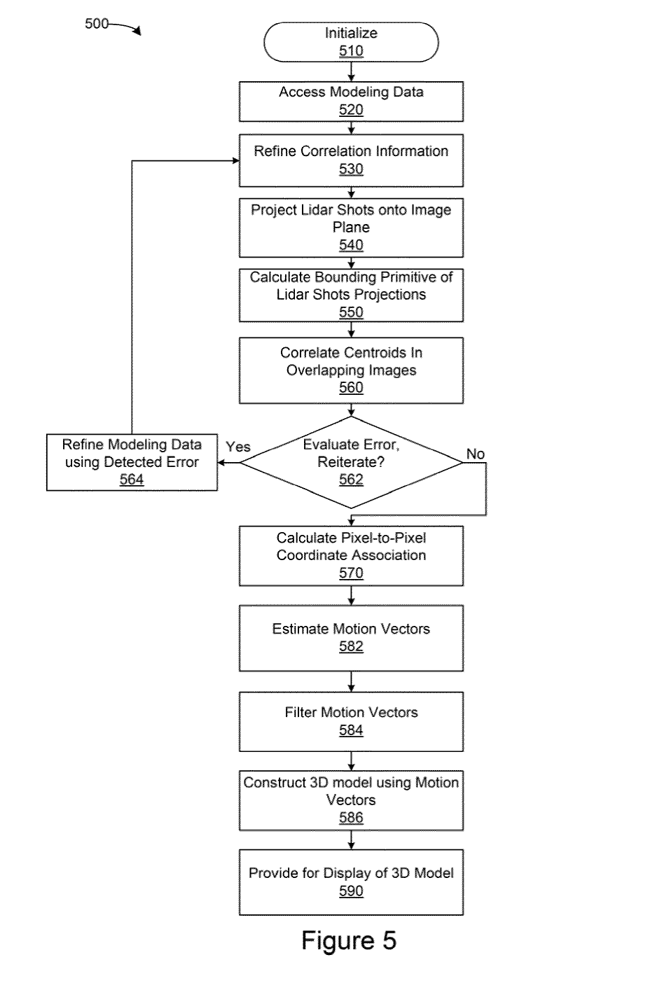

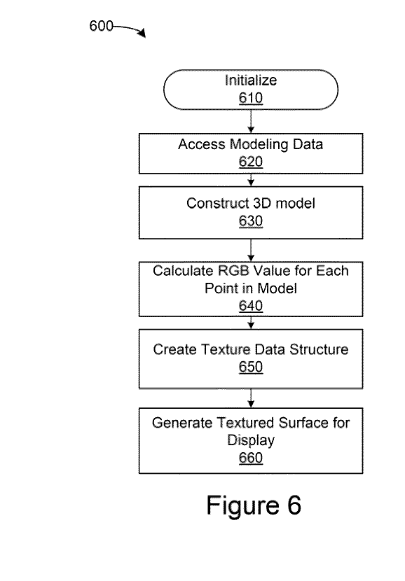

FIG. 5 is a flow diagram of another embodiment of a method 500 for constructing a 3-D model of a subject matter using correlatable EO imagery and lidar data. As described above, the method 500 may be embodied as one or more computer readable instructions stored on a computer-readable storage media. The instructions may be adapted for execution by a computing device, comprising a processor, memory, data storage media, a communications interface, an HMI, and the like.

At step 510, the method 500 is initialized, which may comprise allocating computing resources, data storage media, one or more communication interfaces, and other resources required by the method 500. The initialization may further comprise accessing a computer-readable storage medium upon which computer readable instructions for implementing the method 500 are embodied.

At step 520, modeling data comprising a plurality of correlatable EO images and lidar shots may be accessed. In the FIG. 5 example, the modeling data may include significant EO image overlap (e.g., portions of the subject matter may be captured within 10s, 100s, or more overlapping EO images). As will be described in steps 582-586 below, this large amount of overlapping EO imagery data may be leveraged to construct a 3-D model of the subject matter.

Steps 530-570 may be performed as described above in conjunction with steps 330-370 of FIG. 3. At steps 530-550, the modeling data may be refined, lidar shot projections may be calculated, the lidar shot projections may be set as the centroid of respective bounding primitives (e.g., Voroni cells), and the centroids may be correlated. At steps 560-564, the correlation data may be refined and, at step 562, the method 500 may determine whether steps 530-560 should be reiterated using the refined correlation data. At step 570, pixel-to-pixel coordinate associations may be calculated.

At step 582, the method 500 may calculate point motion vectors for each pixel within the image plane (comprising sequence of overlapping EO images). Pixel point motion vectors may be estimated using techniques developed for image and/or video compression. For example, the motion vector estimation of step 582 may include compression techniques developed by the Motion Pictures Expert Group (MPEG), which are adapted to compress video data by distinguishing between static and dynamic (changing) portions of an EO image sequence (e.g., video stream). The video stream may be compressed by including only the dynamic portions of the stream. Therefore, a video stream may be segregated into full frames (e.g., Intra coded pictures or I-Frames), and predictive or bi-predictive frames (e.g., P-Frames and B-Frames respectively), which may be derived from I-Frames and/or other P/B-Frames in the stream. This segregation may include determining the motion characteristics of various portions (e.g., blocks and sub blocks) of the image frames within the video. At step 582, similar techniques may be leveraged to identify blocks (image patches) of matching pixels within the EO image sequence (e.g., using image-processing techniques). The identification/image processing may be seeded using and pixel-to-pixel coordinate associations calculated at step 570 and/or the bounding primitives and/or correlated centroid positions calculated at steps 550-560.

Step 582 may further include pattern matching on sub blocks (pixel groups) within the EO images using an error metric (e.g., absolute error or squared error) on surrounding areas in successive, overlapping EO images to estimate a motion vector for the sub block. The motion vectors may be applied to pixels in the sub block, and, as described above, image-processing techniques may be used to segment and/or identify the sub blocks. The identifying and/or image processing techniques of step 582 may be seeded as described above (e.g., using pixel-to-pixel coordinate associations, bounding primitives, and the like).

Given the large amount of overlapping EO imagery data, each pixel within an EO image may be a member of plural sub blocks. Therefore, and aggregate motion vector of a pixel may be estimated as a weighted combination of the sub block motion vectors of which it is a member. Since each pixel motion vector is calculated using a combination of plural sub block associations the resulting pixel motion vectors may be statistically robust. As such, in some embodiments, the pixel-motion vector calculation of step 382 may include outlier rejection techniques (e.g., exclude pixel motion vectors from the weighted average that differ from a mean motion vector by greater than a threshold deviation amount) to further increase motion vector accuracy and noise resistance.

Although step 582 describes estimating motion vectors using a sub block linear estimation technique, other optical flow techniques could be used under the teachings of this disclosure. Such techniques may include, but are not limited to phase correlation (inverse of normalized cross-power spectrum), block correlation (sum of absolute difference, normalized cross-correlation), gradient constraint-based registration, Lucas Kanade method, Horn Schunck method, and the like.

In some embodiments, the method 700 may filter the pixel motion vectors at step 584. In an EO image sequence, pixel-specific motion vectors may split, merge, start, and stop depending on the evolving viewability of particular portions of the subject matter. For example, a pixel corresponding to an object on the ground may come into and out of view in various portions of the EO image sequence according to the changing position and orientation of the EO imaging device used to capture the EO image sequence. The predicted motion vector may be estimated using a Kalman-type motion filter. The filtering of step 584 may also be used to smooth noise in motion prediction estimation. In addition, the viewability and/or orthogonalization techniques described above (e.g., in conjunction with step 340 of FIG. 3) may be used to determine vector visibility on a per-image basis (e.g., using a depth map and/or depth polygon approach).

At step 586, the motion vectors may be used to generate a 3-D model of the subject matter using videogrammetry techniques, The resulting 3-D model may be statistically robust, given that each point in the 3-D model (e.g., x, y, z coordinate point) is constructed using a large number of measured pixel coordinates (e.g., the 3-D model leverages the large amount of overlapping EO imagery in the modeling data accessed at step 520). Accordingly, each 3-D point in the model is calculated based upon motion vector data associated with many different pixels. Therefore, “noisy” pixels are unlikely to introduce significant error into the model. In addition, as discussed above, the availability of significant amounts of redundant may allow for the incorporation of heuristic outlier rejection techniques to further insulation the method 500 for noise or other perturbations. The construction of step 586 may use videogrammetry techniques to calculate a 3-D point for each of the pixel-specific motion vectors calculated and/or filtered at step 582 and/or 584.

At step 590, the 3-D model constructed at step 586 may be provided for display via an HMI or other computing device. In addition, the 3-D model may be stored on a data storage media and/or made available on a network for display by one or more remote computing devices as described above in conjunction with step 390 of FIG. 3.

The 3-D models constructed according to methods 300 and/or 500 described above may have color and/or texture data applied thereto. For example, each 3-D point in the 3-D model may be colored by combining the color information contained in the EO images that contributed to the calculation of the 3-D point. For example, the color applied to a 3-D point may be based upon the color information associated with each of the pixels used to construct the corresponding point in the 3-D model (e.g., each pixel in a pixel-to-pixel coordinate association and/or pixels within a pixel-specific motion vector used to calculate the 3-D point). This color data may be stored with the 3-D model data (e.g., as an appendage to each 3-D point in the model) or may be stored separately (e.g., for use in a multi-view graphics engine) in a specialized data structure, such as a texture atlas or the like.

FIG. 7 is a flow diagram of a method 700 for coloring and/or texturing a 3-D model of a subject matter using correlatable EO imagery and lidar data.

At steps 710 and 720, the method may be initialized and modeling data may be accessed as described above. The modeling data may comprise correlatable EO imagery and lidar of a subject matter. At step 730, the modeling data may be used to construct an EO image-based 3-D model of the subject matter. The 3-D model may be constructed using the methods 300 and/or 500 described above.

At step 740, a composite color value (e.g., RGB value) for each pixel within the 3-D model may be estimated by applying a weighted average to pixels that contributed to the calculation of the 3-D point. In the FIG. 3 example, this may comprise averaging two (2) pixels within a pixel-to-pixel coordinate association. In the FIG. 5 example, this may comprise combining pixels contributing to a pixel motion vector used to calculate the 3-D point, and so on.

At step 750, the color values may be stored in a data structure. The data structure may include a texture atlas to provide a plurality of 3-D point-to-color value mappings. Therefore, the data structure may map a color value from a plurality of EO images to each of the 3-D points within the model (e.g., map an RGB color to each x, y, z 3-D point).

At step 760, a textured surface may be generated using the 3-D model and corresponding color information for display to a user. The texture information may allow the color information to be combined into texture primitives and/or a textured surface. The textured surface may or may not include normals. The textured surface may include composite entities, such as splats, texture splats, textured polygons, or the like. Alternatively, or in addition, portions of the 3-D model may be individually colored.

As discussed above, at several points within the 3-D model construction systems and methods discussed above, correlation data associated with the EO imagery and lidar data may be refined using the results of various image-processing techniques. For example, during 3-D model construction, pixel-to-pixel coordinate associations between EO images are calculated using image-processing techniques, which may be seeded using the lidar projection estimates. The pixel-to-pixel coordinate associations may be of a higher spatial resolution and higher precision than the correlation data (e.g., navigation and/or sensor orientation data) used to seed the image processing technique. Therefore, a feedback loop may be provided, whereby the 3-D correlation data refinements may flow to other systems and methods (e.g., an acquisition system or method, or the like).

FIG. 7 is a flow diagram of one embodiment of a method 700 for refining navigation and/or sensor pose data using EO image-based 3-D modeling data. At steps 710 and 720, the method 700 may be initialized, and a set of modeling data may be accessed as described above.

At step 730, the correlation data may be refined (e.g., using the point cloud matching technique described above). The refining of step 730 may provide for more accurate lidar shot projections/mappings at step 740. The refining of step 730 may include applying a point cloud matching technique to the lidar data and correlation data. Examples of such techniques are provided above in conjunction with step 330 of FIG. 3.

The correlation data refinements calculated at step 730 may be applicable to other portions of the modeling data accessed at step 720. For example, the correlation data may be off by a particular constant amount (e.g., offset) and/or according to a recurring error pattern. Therefore, the refinements to the correlation data (e.g., error detected in the correlation data as well as errors detected at steps 750 and 780 discussed below) may flow to a feedback path 701. Although not shown in FIG. 7, the feedback path 701 may be coupled to an HMI or other interface to notify a user (or other process) of any correlation data errors. In addition, the feedback path 701 may flow to an acquisition system or method (not shown) to allow for continuous correlation data refinement. For example, if the acquisition system captures navigation and/or sensor orientation data, the feedback path 701 may be used by the acquisition system to refine the positioning data it captures in real-time (e.g., correct an offset error, or the like). Similarly, the feedback path 701 may flow to a data storage module to refine other sets of navigation data previously captured by the system. For instance, the acquisition system may capture navigation data as part of a surveying operation, and the navigation and/or orientation data refinements calculated by the methods 700 may be used to refine the survey data. Alternatively, or in addition, the modeling data of step 720 may be one of a plurality of point clouds constituting a super-resolution model of the subject matter, and the refinements/errors sent via the feedback path 701 may be used to refine the other sets of modeling data. This iterative refinement may allow for more accurate merging of 3-D models produced using the various sets of modeling data.

At step 740, the refined correlation data may be used to project/map the lidar shots onto the EO images as described above in conjunction with step 340 of FIG. 3. The projections/mappings may then be set as the centroid of respective bounding primitives within the EO images as described above in conjunction with step 350 of FIG. 3. The centroids may be correlated using an image processing technique as described above in conjunction with step 360 of FIG. 3.

At step 750, the centroid correlations of step 740 may be used to refine the correlation data. As described above, the correlation of step 740 may be performed using an image processing technique applied to high-resolution EO images. Therefore, the resulting centroid correlations may be more accurate (and more reliable) than the correlation data used to make the initial lidar shot projection estimates. As such, at step 750, a difference between the lidar shot projection estimates calculated using the correlation data the correlated centroid positions may be determined. The differences may represent an error in the correlation data. The error(s) may be used to refine the navigation data. As discussed above, in some embodiments, the refinements and/or errors may flow to the feedback path 701.

At step 760, the method 700 may determine whether steps 730-750 should be reiterated using the refined correlation data calculated at step 750. The determining of step 760 may be performed substantially as described above in conjunction with step 362 of FIG. 3. If steps 730-750 are to be reiterated, the flow may return to step 730; otherwise, the flow may continue to step 770.

At step 770, pixel-to-pixel coordinate associations between EO images may be calculated as described above in conjunction with step 370 of FIG. 3. The pixel-to-pixel coordinate associations may then be used to construct a 3-D model of the subject matter (e.g., using an image processing technique, such as a stereo imaging technique, photogrammetry, or the like).

At step 780, the correlation data may be further refined by incorporating the correlation data (e.g., navigation data and/or sensor orientation) into the 3-D model of the subject matter constructed at step 770. As discussed above, since the 3-D model is of a higher-resolution and/or is constructed using statistically robust techniques, any divergence between the correlation data and the 3-D model may represent an error in the correlation data. Therefore, the correlation data may be refined to conform to the 3-D model. As discussed above, correlation data refinements (errors) detected at step 780 may flow to the feedback path 701 for further analysis and/or modeling data refinement.

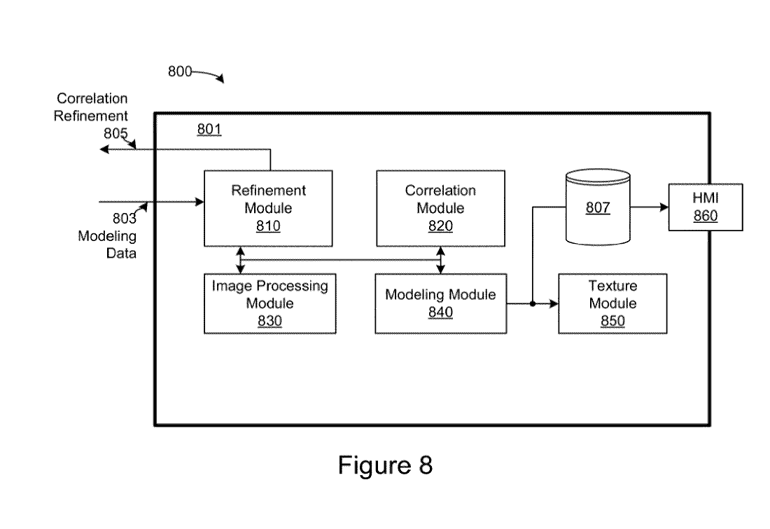

FIG. 8 is a block diagram of one embodiment of a system 800 for constructing a 3-D model of a subject matter using lidar-assisted multi-image matching techniques. In FIG. 8, the various components of the system 800 are depicted as distinct software modules, which may include a refinement module, a correlation module 820, an image-processing module 830, a modeling module 840, a texture module 850, and a Human Machine Interface (HMI) module 860. Each of the modules 810-860 may be embodied on a computer-readable storage media as computer executable instructions and/or as distinct software modules (e.g., instructions operable on a processor).

As depicted in FIG. 8, the modules 810-860 may be configured to be executed by a computing device 801, which may comprise one or more processors (not shown), memory units (not shown), a data store 807, a communications interface (not shown), one or more input/output devices (not shown), an HMI 860, and the like. The modules 810-860 may be tied to the computing device (e.g., the modules 810-860 may be embodied on the data store 807 and/or another data storage medium communicatively coupled to the computing device 801).

The refinement module 810 is configured to receive modeling data 803 from an acquisition system (not shown) or another source. The modeling data 803 may comprise a plurality of correlatable EO images and lidar shots of a subject matter. The EO images and lidar shots may be correlated to one another using correlation data associated therewith. As discussed above, the correlation data may include navigation and/or sensor orientation estimates, time stamp data, synchronism information, movement pattern information, or the like.

Upon receiving the modeling data 803, the refinement module 810 refines the correlation data therein using a point cloud matching technique (e.g., using a refinement technique as discussed above in conjunction with FIGS. 3, 5, and 7). The refinement module 810 may output a correlation refinement signal 805, by which refinements to the correlation data and/or correlation data errors may be returned to an acquisition system or method (not shown). The correlation refinement signal 805 may allow an acquisition system (or other process) to detect, diagnose, and/or correct correlation data errors (e.g., navigation errors, sensor pose errors, and the like). In addition, the correlation refinement signal 805 may flow to the HMI module 860 for display.

The refined modeling data flows to the correlation module 820, which may project/map lidar shots onto an image plane (comprising the overlapping EO images) using the correlation data. The correlation module 820 may set each lidar shot projection within each EO image as the centroid of a respective bounding primitive (e.g., Voroni cell) therein. The correlation module 820 may define the boundaries of the bounding primitives according to a selected expansion algorithm (e.g., the boundaries of a Voroni cell bounding primitive may be defined according to a distance metric).

The image plane, and constituent EO images having bounding primitives overlaid thereon, flow to the image-processing module 830, which may be configured to correlate the centroids of associated bounding primitives (e.g., centroids of the same lidar shot projection within a selected plurality of overlapping EO images). The correlation performed by the image-processing module 830 is seeded using the lidar shot projections calculated by the correlation module 820. The correlation centroid positions flow to the refinement module 810, which uses the correlations to refine the correlation data. As described above, the correlation data refinements may flow to the correlation refinement signal 805 and/or to the HMI module 860.

In addition, the refinement module 810 may determine whether the correlation module 820 should re-project the lidar shots onto the image plane using the refined correlation data. As discussed above, this determination may be based upon one or more threshold conditions, which may balance a cost of re-processing the modeling data using the refined correlation data against a cost of the re-processing. If the lidar shots are to be re-projected onto the image plane, the refined modeling data flows to the correlation module 820, where the lidar shots are re-processed as discussed above (e.g., re-projected onto the EO images, set as the centroid of respective bounding primitives, re-correlated, and so on).

After an acceptable accuracy threshold is reached (or a maximum number of processing iterations has been performed), the modeling data (including the correlated bounding primitives) flow to the image processing module 830, which calculates pixel-to-pixel coordinate associations between overlapping EO images. The associations may be calculated using an image processing technique, which, as discussed above, is seeded using the bounding primitives and/or the correlated centroid positions thereof.

The pixel-to-pixel coordinate associations flow to the modeling module 840, which constructs a 3-D model of the subject matter therefrom using an image processing technique, such as stereo imaging, photogrammetry, or the like. If pixel-to-pixel associations exist between more than two (2) EO images, the modeling module 840 refines the 3-D point using error minimization. The 3-D point solution may flow back to the refinement module 810, which may incorporate the correlation data (e.g., navigation and/or sensor orientation estimates) into the 3-D model to further refine the correlation data.

In other embodiments, the modeling module 840 may construct the 3-D model of the subject matter using videogrammetry techniques. Videogrammetry techniques may be applied to modeling data 803 that comprises a large amount of overlapping EO imagery data (e.g., wherein a particular portion of the subject matter is captured within 10s, 100s, or more overlapping EO images).

To apply videogrammetry techniques, the image-processing module 840 may be configured to estimate pixel-specific point motion vectors for portions within the EO images sequence as described above in conjunction with FIG. 5. The motion vector estimation may be seeded using the lidar shot projections (e.g., the correlated bounding primitives calculated using the lidar shot mappings). The motion vector calculation may leverage video compression techniques, such as the techniques used to compress MPEG video. In other embodiments, the image-processing module 840 may estimate the point motion vectors using an optical flow technique, such as a phase correlation technique, a block correlation technique, a gradient constraint-base registration technique, the Lucas Kanade method, the Horn Schucnk method, or the like.

The image-processing module 840 may filter the pixel-specific motion vectors to remove noise and/or to handle vector splitting, merging, starting and stopping caused by the evolving viewability of portions of the subject matter as determined by the EO imagery scale. The predicted motion for pixels that are not intermittently visible may be estimated using a motion filter. The filtering may also be used in smoothing noise in motion prediction estimation.

The pixel-specific motion vectors calculated by the image-processing module 840 flow to the modeling module 840, which may be configured to construct a 3-D model of the subject matter therefrom (e.g., using a videogrammetry modeling technique). The large number of measured pixel coordinates for each 3-D point may enable the 3-D model constructed using the pixel-specific motion vectors to be statistically robust.

The 3-D model constructed by the modeling module 840 (using videogrammetry techniques and/or photogrammetry techniques) may flow to a data store 807 for storage. In addition, the modeling data (and 3-D model constructed therefrom) may flow to the texture module 850, which may apply color and/or texture information to the 3-D model. The texture of a particular point in the 3-D model may be calculated as described above in conjunction with FIG. 7. For example, the color of each 3-D point may be estimated as a weighted average of the colors the pixels that contributed to the point (e.g., the pixels used to calculate the 3-D point and/or pixels of the pixel-specific motion vector used to calculate the 3-D may contribute to the point's color).

The texture module 850 may generate a texture atlas or other data structure to map each 3-D point in the model to a corresponding color (e.g., the texture atlas may comprise a color value for each x,y,z point within the 3-D model). The texture module 850 may be further configured to generate a textured surface for the model (e.g., surface comprising normals) comprising composite entities, such as texture splats, textured polygons, or the like. Alternatively, or in addition, portions of the 3-D model may be individually colored (e.g., colored on a per 3-D point basis).

The texture module 850 may store the texture atlas (or other data structure) in the data store 807. The texture atlas may be made available to the HMI 860, to allow for displaying color information on the model.

The HMI module 860 may be configured to access the 3-D model and texture information from the data store 807 or other source (e.g., directly from the modules 840 and 850). The HMI module 860 may include and/or be communicatively coupled to various input/output devices of the computing device 801, such as a display (not shown), keyboard (not shown), mouse (not shown), communications interface (not shown), or the like.

The HMI module 860 may be configured to present the 3-D model to a user via a display, network interface, printer, or other human-machine interface. Therefore, the HMI 860 may include a renderer (not shown) capable of rendering the 3-D model for display from various points-of-view. The HMI module 860 may be further configured to apply color information to the 3-D model (e.g., using a texture atlas stored in the data store 807). The HMI module 860 may allow other interactions with the 3-D model including, but not limited to: transmitting the model for viewing on a remote computing device; zooming into particular portions of the 3-D model; applying one or more filters to the 3-D model; applying color and/or texture data to the 3-D model; or the like.

The above description provides numerous specific details for a thorough understanding of the embodiments described herein. However, those of skill in the art will recognize that one or more of the specific details may be omitted, or other methods, components, or materials may be used. In some cases, operations are not shown or described in detail.

Furthermore, the described features, operations, or characteristics may be combined in any suitable manner in one or more embodiments. It will also be readily understood that the order of the steps or actions of the methods described in connection with the embodiments disclosed may be changed. Thus, any order in the drawings or Detailed Description is for illustrative purposes only and is not meant to imply a required order, unless specified to require an order.

Embodiments may include various steps, which may be embodied in machine-executable instructions to be executed by a general-purpose or special-purpose computer (or other electronic device). Alternatively, the steps may be performed by hardware components that include specific logic for performing the steps, or by a combination of hardware, software, and/or firmware.

Embodiments may also be provided as a computer program product, including a computer-readable medium having stored instructions thereon that may be used to program a computer (or other electronic device) to perform processes described herein. The computer-readable medium may include, but is not limited to: hard drives, floppy diskettes, optical discs, CD-ROMs, DVD-ROMs, ROMs, RAMs, EPROMs, EEPROMs, magnetic or optical cards, solid-state memory devices, or other types of media/machine-readable medium suitable for storing electronic instructions.

As used herein, a software module or component may include any type of computer instruction or computer executable code located within a memory device and/or transmitted as electronic signals over a system bus or wired or wireless network. A software module may, for instance, include one or more physical or logical blocks of computer instructions, which may be organized as a routine, program, object, component, data structure, etc., that perform one or more tasks or implements particular abstract data types.

In certain embodiments, a particular software module may include disparate instructions stored in different locations of a memory device, which together implement the described functionality of the module. Indeed, a module may include a single instruction or many instructions, and may be distributed over several different code segments, among different programs, and across several memory devices. Some embodiments may be practiced in a distributed computing environment where tasks are performed by a remote processing device linked through a communications network. In a distributed computing environment, software modules may be located in local and/or remote memory storage devices. In addition, data being tied or rendered together in a database record may be resident in the same memory device, or across several memory devices, and may be linked together in fields of a record in a database across a network.

It will be understood by those having skill in the art that many changes may be made to the details of the above-described embodiments without departing from the underlying principles of this disclosure.

What is claimed is:

1. A computer-readable storage medium comprising executable instructions to cause a computing device to perform a method for constructing a model of a subject matter, the method comprising:
accessing modeling data comprising a plurality of overlapping EO images of the subject matter; a plurality of lidar shots of the subject matter, and correlation data associated with each of the EO images and lidar shots;
projecting each of the lidar shots onto two or more of the EO images using the correlation data;
calculating pixel-to-pixel coordinate associations between the overlapping EO images, wherein the pixel-to-pixel coordinate associations are calculated using the lidar shot projections; and
constructing a 3-D model of the subject matter using the pixel-to-pixel coordinate associations.

2. The computer-readable storage medium of claim 1, wherein projecting a lidar shot onto two or more EO images comprises back projecting a footprint of the lidar shot onto respective image patches within the two or more EO images.

3. The computer-readable storage medium of claim 2, wherein the correlation data of the lidar shot comprises navigation data indicative of a location of a lidar when the lidar shot was acquired, and wherein the lidar shot is back projected onto the two or more EO images using the navigation data.

4. The computer-readable storage medium of claim 3, wherein the correlation data of the lidar shot further comprises orientation data indicative of an orientation of the lidar at the time the lidar shot was acquired, and wherein the lidar shot is back projected onto the two or more EO images using the navigation data and the orientation data.

5. The computer-readable storage medium of claim 2, the method further comprising, setting the lidar shot projections within the two or more EO images as centroids of respective bounding primitives within each of the two or more EO images.

6. The computer-readable storage medium of claim 5, wherein the bounding primitives are Voroni cells.

7. The computer-readable storage medium of claim 5, wherein calculating a pixel-to-pixel coordinate association between the two or more EO images comprises correlating the centroids of the bounding primitives within the two or more EO images.

8. The computer-readable storage medium of claim 7, wherein the centroids of the bounding primitives are correlated using an image processing technique, the method further comprising seeding the centroid correlation image processing technique using the bounding primitives.

9. The computer-readable storage medium of claim 7, wherein the pixel-to-pixel coordinate associations between the two or more EO images are calculated using an image processing technique, the method further comprising seeding the pixel-to-pixel coordinate association image processing technique using the correlated bounding primitive centroid locations within the two or more EO images.

10. The computer-readable storage medium of claim 2, wherein constructing a 3-D model of the subject matter using the pixel-to-pixel coordinate associations comprises photogrammetrically calculating a 3-D point for each associated pair of pixels in the pixel-to-pixel coordinate associations.

11. The computer-readable storage medium of claim 1, wherein a lidar shot is projected within three or more overlapping EO images, the method further comprising:
photogrammetrically calculating a 3-D point using each of the two or more pixel-to-pixel coordinate associations; and
calculating the 3-D point by minimizing an error metric between the two or more 3-D points photogrammetrically calculated using the two or more pixel-to-pixel coordinate associations.

12. The computer-readable storage medium of claim 1, further comprising calculating point motion vectors for each of the pixel-to-pixel coordinate associations, and wherein the 3-D model of the subject matter is constructed using the point motion vectors.

13. The computer-readable storage medium of claim 12, wherein the point motion vectors are calculated using one selected from the group consisting of an optical flow technique, phase correlation, a block correlation, and a gradient constraint-based registration.

14. The computer-readable storage medium of claim 12, further comprising filtering the point motion vectors, wherein the 3-D model of the subject matter is constructed using the filtered point motion vectors.

15. The computer-readable storage medium of claim 12, wherein a particular portion of the subject matter is captured within 3 or more overlapping EO images.

16. The computer-readable storage medium of claim 1, wherein the EO images in the modeling data are captured using a video camera.

17. The computer-readable storage medium of claim 1, wherein the correlation data comprises navigation data, and wherein the navigation data comprises data indicative of a position and orientation of a lidar as each of the lidar shots were captured, and wherein the navigation data further comprises data indicative of a position and orientation of an EO imaging device as each of the EO images were captured.

18. The computer-readable storage medium of claim 17, the method further comprising estimating a position and orientation of the lidar as each of the lidar shots were captured using the navigation data.

19. The computer-readable storage medium of claim 17, further comprising refining the navigation data using the lidar shots and the estimates of the lidar position and orientation as each of the lidar shots were captured.

20. The computer-readable storage medium of claim 19, wherein the refining comprises applying a point cloud matching technique to the lidar shots and the lidar position and orientation estimates.

21. The computer-readable storage medium of claim 17, further comprising estimating a position and orientation of the EO imaging device as each of the EO images were acquired using the refined navigation data, and wherein each of the lidar shots are projected onto two or more EO images based on the refined navigation data.

22. The computer-readable storage medium of claim 17, wherein a lidar shot projects into two or more EO images, the method further comprising:
setting the projection of a lidar shot as the centroid of a bounding primitive within the two or more EO images into which the lidar shot projects;
seeding a centroid correlation image processing technique using the lidar shot projections;
correlating the centroids of the bounding primitives within the two or more EO images; and
refining the navigation data using the correlated centroid positions within the two or more EO images.

23. The computer-readable storage medium of claim 22, wherein refining the navigation data using the correlated centroid positions comprises correcting the navigation data of the lidar shot to conform to the correlated centroid positions within the two or more EO images.

24. The computer-readable storage medium of claim 21, the method further comprising:
incorporating the refined navigation data into the 3-D model of the subject matter; and
refining the navigation by conforming the navigation data to the 3-D model.

25. The computer-readable storage medium of claim 24, wherein refining the navigation data comprises conforming the navigation and orientation data indicative of a position and orientation of the lidar as each of the lidar shots were acquired to conform to the lidar shot projections within the 3-D model.

26. The computer-readable storage medium of claim 1, the method further comprising calculating a color value for each of the 3-D points in the 3-D model, and wherein a color value of a 3-D point comprises a combination of color values of the EO image pixels used to calculate position of the 3-D point.

27. The computer-readable storage medium of claim 26, wherein the color of the 3-D point comprises a weighted average of the color values of the EO image pixels of one or more pixel-to-pixel coordinate associations used to calculate the 3-D point.

28. The computer-readable storage medium of claim 26, wherein the color of the 3-D point comprises a weighted average of the color values of the EO image pixels within a motion vector used to calculate the 3-D point.

29. The computer-readable storage medium of claim 26, the method further comprising generating a texture atlas to map color values from a plurality of EO images to each of the 3-D points of the 3-D model.

30. The computer-readable storage medium of claim 26, the method further comprising generating one or more textured primitives to provide color values to one or more of the 3-D points of the 3-D model, and wherein the textured primitives include one of a splat, a textured plat, and a textured polygon.

31. A method for constructing a model of a subject matter using a computing device comprising a processor, the method comprising:
acquiring modeling data comprising a plurality of overlapping EO images of the subject matter captured using an EO imaging device, a plurality of lidar shots of the subject matter captured using a lidar, and correlation data;
the computing device estimating a pose of the EO imaging device as each EO image was acquired and estimating a pose of the lidar as each of the lidar shots was acquired;
the computing device projecting each of the lidar shots onto two or more of the EO images using the pose estimates;
the computing device defining bounding primitives for each of the lidar shot projections on the image plane;
calculating pixel-to-pixel coordinate associations between the overlapping EO images, wherein the pixel-to-pixel coordinate associations are calculated using an image processing technique seeded using the bounding primitives; and
constructing a 3-D model of the subject matter using the pixel-to-pixel coordinate associations.

32. A system for constructing a 3-D model of a subject matter using modeling data comprising a plurality of EO images of the subject matter, a plurality of lidar shots of the subject matter, and correlation data associated with the EO images and the lidar shots, comprising:
a computing device comprising a processor;
a correlation module operable on the processor and configured to project each of the plurality of lidar shots onto two or more EO images and to set each of the lidar shot projections as centroids of respective bounding primitives within the respective EO images;
an image processing module operable on the processor and communicatively coupled to the correlation module, the image processing module configured to calculate pixel-to-pixel coordinate associations between the overlapping EO images, wherein the pixel-to-pixel coordinate associations are calculated using an image processing technique seeded using the bounding primitives; and
a modeling module operable on the processor and communicatively coupled to the image processing module, the modeling module configured to construct a 3-D model of the subject matter using the pixel-to-pixel coordinate associations.
